(19) United States
(12) Patent Application Publication
(10) Pub. No.: US 2008/0122826 A1
(43) Pub. Date: May 29, 2008

(54) Driving circuit for adjusting common voltage and liquid crystal display using same

(75) Inventors: Chien-Fan Tung, Miao-Li (TW); Deng-Tzung Tang, Miao-Li (TW); Shun-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/998,023

(22) Filed: Nov. 27, 2007

(30) Foreign Application Priority Data
Nov. 27, 2006 (TW) 95143794

(51) Int. Cl. G09G 5/00; G09G 3/36

(52) U.S. Cl. 345/211; 345/98

(57) ABSTRACT

An exemplary LCD (30) includes a liquid crystal panel (31) configured for displaying images and a driving circuit (30). The driving circuit includes a pulse generator configured for providing a pulse signal, and a charge pump (315) configured for provide a common voltage to the liquid crystal panel according to the pulse signal. The common voltage is adjusted by adjusting a duty ratio of the signal pulse, and the precision of adjustment of the common voltage is determined according to a resolution of the pulse signal.

### FIELD OF THE INVENTION

The present invention relates to a driving circuit that is able to adjust a common voltage by adjusting a duty ratio of a pulse signal provided by a pulse generator, and to a liquid crystal display (LCD) using the driving circuit.

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

In general, an LCD usually includes a driving circuit for adjusting a common voltage thereof.

Referring to FIG. 5, a typical driving circuit 10 used in an LCD includes a voltage input terminal 110, a voltage output terminal 120, two resistors 101, 102, two capacitors 103, 104 and a variable resistor 150. The voltage input terminal 110 is connected to ground via the first resistor 101 and the first capacitor 103 in series. The voltage input terminal 110 is also connected to ground via the first resistor 101, the second resistor 102 and the variable resistor 105 in series. The voltage input terminal 110 is further connected to ground via the first resistor 101 and the second capacitor 104 in series. The voltage output terminal 120 is connected to ground via the second capacitor 104. The voltage input terminal 110 has a direct current (DC) voltage applied thereto. The voltage output terminal 120 outputs a voltage equal to a voltage over the second resistor 102 and the variable resistor 105.

When the variable resistor 105 is modulated, the voltage output terminal 120 outputs a voltage in proportion to a resistance of the variable resistor 105. Normally the modulation is performed manually. Thus, the driving circuit 10 has low precision and tends to age and wear rather quickly.

To overcome these deficiencies, a digital variable resistor is adopted in another kind of driving circuit for an LCD. Referring to FIG. 6, a driving circuit 20 employing a digital variable resistor is shown. The driving circuit 20 includes a converter 210, a plurality of resistors 220, and a plurality of switches 230. The resistors 220 together constitute a series branch. One end of the series branch has a voltage defined as V_{dd} applied thereto, and the other end of the series branch is connected to ground.

The converter 210 includes a plurality of input terminals 211 and a plurality of output terminals 212. Each of the switches 230 includes a first end (not labeled), a second end (not labeled), and a controlling end (not labeled). Each of the input terminals 211 receives a digital control signal. Each of the output terminals 212 is connected to the controlling end of the corresponding switch 230. Each of the first ends of the switches 230 is connected to a node between two adjacent connected resistors 220. The second ends of the switches 230 are connected to a voltage output terminal 231. The voltage output terminal 231 provides a common voltage to a liquid crystal panel (not shown).

The input terminals 211 are used to receive a plurality of digital control signals. The converter 210 converts the digital control signals into a plurality of pulse signals. Each of the output terminals 212 provides a pulse signal to the controlling end of the corresponding switch 230, such that one of the switches 230 is turned on and the others are turned off according to the pulse signals. Thus, the V_{dd} is provided to the voltage output terminal 231 via part of the resistors 220 in series and the on-state switch 230. The voltage output terminal 231 and the node connecting to the on-state switch 230 have an equivalent voltage. The voltage of the node is a divider of V_{dd}, and is determined by the group of resistors 220 which are actually functioning.

When the digital control signals received by the converter 210 change, the common voltage correspondingly changes. Thus the common voltage can be adjusted by changing the digital control signals. The digital control signals can in turn be generated according to a user's instruction signal.

However, the driving circuit 20 is large and complicated due to the numerous resistors 220 and other electrical elements. The adjusting of the common voltage is complicated because of the operation of the resistors 220 and other electrical elements. In addition, a precision of adjusting depends on the total amount of resistors 220. The total amount of resistors 220 is finite, and accordingly the precision of adjusting is limited. In summary, the driving circuit 20 and the LCD using the driving circuit 20 are complicated, and do not necessarily provide precise adjusting of the common voltage.

What are needed, therefore, is a driving circuit and an LCD using the driving circuit that can overcome the above-described deficiencies.

### SUMMARY

In one preferred embodiment, an LCD includes a liquid crystal panel configured for displaying images and a driving circuit. The driving circuit includes a pulse generator configured for providing a pulse signal, and a charge pump configured for provide a common voltage to the liquid crystal panel according to the pulse signal. The common voltage is adjusted by adjusting a duty ratio of the signal pulse, and the precision of adjustment of the common voltage is changed according to a resolution of the pulse signal.

Other novel features and advantages will become more apparent from the following detailed description when taken in conjunction with the accompanying drawings, in which:

### BRIEF DESCRIPTION OF THE DRAWINGS

FIG. 1 is an abbreviated block diagram including circuitry of an LCD according to a first embodiment of the present invention, the LCD including a pulse width modulator (PWM) and a charge pump.

FIG. 2 is essentially a circuit diagram of the charge pump of FIG. 1.

FIG. 3 is a timing chart of signals transmitted in the PWM and the charge pump of FIG. 1.

FIG. 4 is an abbreviated block diagram including circuitry of an LCD according to a second embodiment of the present invention.

FIG. 5 is a circuit diagram of a conventional driving circuit typically used in an LCD.

FIG. 6 is a circuit diagram of another conventional driving circuit typically used in an LCD.

### DETAILED DESCRIPTION OF PREFERRED EMBODIMENTS

Reference will now be made to the drawings to describe preferred and exemplary embodiments of the present invention in detail.

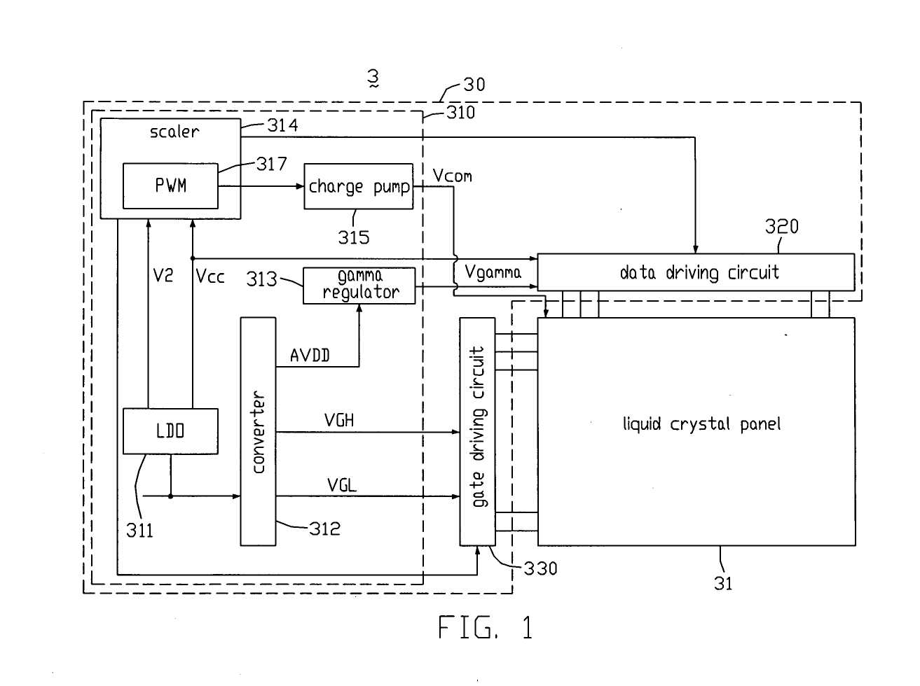

Referring to FIG. 1, this is an abbreviated block diagram including circuitry of an LCD 3 according to a first embodiment of the present invention. The LCD 3 includes a driving circuit 30 and a liquid crystal panel 31. The driving circuit 30 is used to drive the liquid crystal panel 31.

The driving circuit 30 includes a processing circuit 310, a data driving circuit 320 for providing a plurality of gray scale voltages to the liquid crystal panel 31, and a gate driving circuit 330 for providing a plurality of scanning signals to the liquid crystal panel 31. The processing circuit 310 includes a low dropout regulator (LDO) 311, a converter 312, a gamma regulator 313, a scaler 314, and a charge pump 315. The scaler 314 includes a pulse width modulator (PWM) 317. The LDO 311 and the converter 312 receive a direct current (DC) voltage from a power source (not shown). The LDO 311 provides a driving voltage “Vcc” to the data driving circuit 320 and the scaler 314. The LDO 311 also provides a driving voltage “V2” to the PWM 317.

The converter 312 provides a high level gate voltage “VGH” and a low level gate voltage “VGL” to the gate driving circuit 330. The converter 312 also provides a main driving voltage “AVDD” to the gamma regulator 313. The gamma regulator 313 divides the main driving voltage “AVDD” so as to provide a gamma voltage “Vgamma” to the data driving circuit 320.

The scaler 314 provides a plurality of gate control signals to the gate driving circuit 330, and a plurality of data control signals to the data driving circuit 320. The PWM 317 provides a periodic pulse signal to the charge pump 315. The charge pump 315 and the PWM 317 together constitute a common voltage modulator (not labeled).

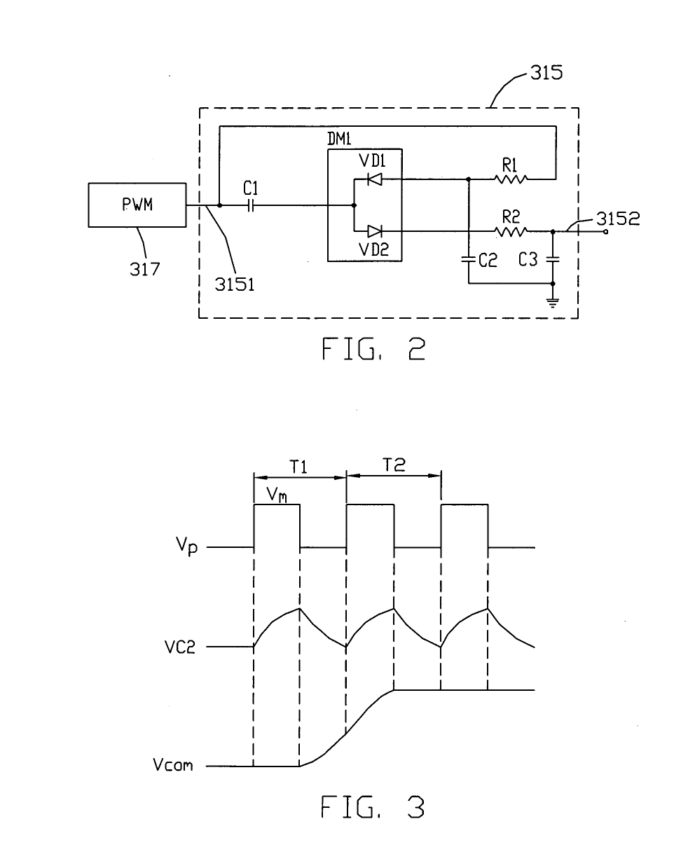

Referring also to FIG. 2, the charge pump 315 includes a voltage input terminal 3151, a first capacitor C1, a second capacitor C2, a third capacitor C3, a first resistor R1, a second resistor R2, a switching member DM1, and a voltage output terminal 3152. The switching member DM1 includes a first diode VD1 and a second diode VD2. The first and second diodes VD1, VD2 have the same electrical characteristics. A voltage drop of the first and second diodes VD1, VD2 is Vd.

The voltage input terminal 3151 is connected to ground via the resistor R1, a positive pole and a negative pole of the first diode VD1, a positive pole and a negative pole of the second diode VD2, the second resistor R2, and the third capacitor C3 in series. The voltage input terminal 3151 is also connected to the positive pole of the second diode VD2 via the first capacitor C1. The voltage output terminal 3152 is connected to ground via the third capacitor C3. The second capacitor C2 is connected between the positive pole of the first diode VD1 and ground. A clamp voltage of the second capacitor C2 is defined as Vc2. The voltage input terminal 3151 is further connected to the PWM 317. The voltage output terminal 3152 is also connected to the liquid crystal panel 31 for providing a common voltage to the liquid crystal panel 31.

Referring also to FIG. 3, this shows a plurality of waveforms of the periodic pulse signal Vp, the clamp voltage Vc2, and the common voltage Vcom. The pulse signal Vp is provided to the charge pump 315. The common voltage Vcom is provided to the liquid crystal panel 31. A highest value of the pulse signal Vp is Vm.

Generally, operation of the processing circuit 310 is as follows. During a first half of a period T1, the PWM 317 provides the pulse signal Vp to the voltage input terminal 3151 and a load current is generated. When the load current flows through the first resistor R1 to the second capacitor C2, the second capacitor C2 is charged, and the load current is integrated to V1. That is, the clamp voltage of C2 is V1 now. Thus, the common voltage provided by the voltage output terminal 3152 is 0 during the first half of the period T1.

During a second half of the period T1, the pulse signal is dropped to a low level voltage such as, in the illustrated embodiment, 0. The second capacitor C2 begins to discharge, and the first diode VD1 is open. Thus, the first capacitor C1 is charged by the second capacitor C2 via the first diode VD1. Because the voltage drop of the first diode VD1 is Vd, the first capacitor C1 is charged to a voltage of (V1−Vd). That is, the positive pole of the second diode VD2 has a (V1−Vd) voltage. In the meantime, the third capacitor C3 is charged to a voltage of (V1−2Vd) by the first capacitor C1 via the second diode VD2 and the second resistor R2, and by the second capacitor C2 via the first diode VD1, the second diode VD2 and the second resistor R2. Therefore, the common voltage provided by the voltage output terminal 3152 is gradually stepped up to (V1−2Vd).

During a first half of a period T2, the pulse signal Vp is changed to a high level voltage of Vm again. The voltage of the positive pole of the second diode VD2 is changed to (V1+Vm−Vd) because of a coupling effect of the first capacitor C1. This results in a reverse blocking state of the first diode VD1. The second capacitor C2 is charged again by a load current via the first resistor R1, and the load current is integrated to V1 when flowing to the second capacitor C2. The third capacitor C3 is charged to (V1+Vm−2Vd) by the first capacitor C1 via the second diode VD2 and the second resistor R2. Therefore, the common voltage Vcom provided by the voltage output terminal 3152 is gradually stepped up from (V1−2Vd) to (V1+Vm−2Vd).

During a second half of the period T2, the pulse signal Vp is changed to 0 again. The second capacitor C2 discharges electricity to the voltage output terminal 3152 through the second diode VD2 and the second resistor R2. The common voltage Vcom is maintained at (V1+Vm−2Vd).

After the period T2, the common voltage Vcom provided by the voltage output terminal 3120 is maintained.

As described above, the common voltage Vcom eventually reaches (V1+Vm−2Vd). Thus, when the value of V1 is changed, the common voltage is correspondingly changed. Further, when a duty ratio of the pulse signal Vp is changed, the integrating voltage of the second capacitor C2 is changed, and the common voltage Vcom is changed. In this case, by changing the duty ratio of the pulse signal Vp, the common voltage Vcom can be adjusted. When the duty ratio of the pulse signal Vp is enlarged, the common voltage Vcom is higher. For instance, a common voltage Vcom is 4.7 V when a duty ratio of the pulse signal Vp is 50%, and the common voltage Vcom is changed to 5.0 V when the duty ratio of the pulse signal Vp is changed to 60%.

Furthermore, by changing a resolution of the PWM 317, a precision of adjusting of the common voltage Vcom can be set. For instance, if a precision of 10 mV (millivolts) within a range of voltages spanning 3.3 V is needed, the resolution of the PWM 317 can be set to 9 bits, which is a binary quotient of the range of voltage (3.3 V) to the precision (10 mV). Generally, the range of voltage of the common voltage Vcom is predetermined.

The driving circuit 30 includes the PWM 317, and the driving circuit 30 can adjust the common voltage by changing the duty ratio of the pulse signal provided by the PWM 317. Thus the driving circuit 30 does not need many resistors in order to provide adjusting of the common voltage. That is, the driving circuit 30 is simple.

Because the pulse signal of the PWM 317 has a wide range of variation, a high precision of the variation of the common voltage can be achieved by setting the resolution of the PWM 317. That is, the driving circuit 30 can provide very precise adjusting of the common voltage.

In addition, the adjustment of the common voltage is achieved simply by modulating the PWM 317, without the need to involve other electrical elements. Thus, the process of adjusting of common voltage is simple. Furthermore, because the driving circuit 30 has a simple structure, the driving circuit 30 is less prone to breaks down. Thus the driving circuit 30 can work more reliably.

The PWM 317 is a normal component in a contemporary driving circuit. A main cost of the driving circuit 30 is attributable to the charge pump 315. According to one survey, a cost of a normal charge pump is only one fifth or even as little as one twentieth of a total cost of a conventional driving circuit. Thus, the driving circuit 30 is cost-effective.

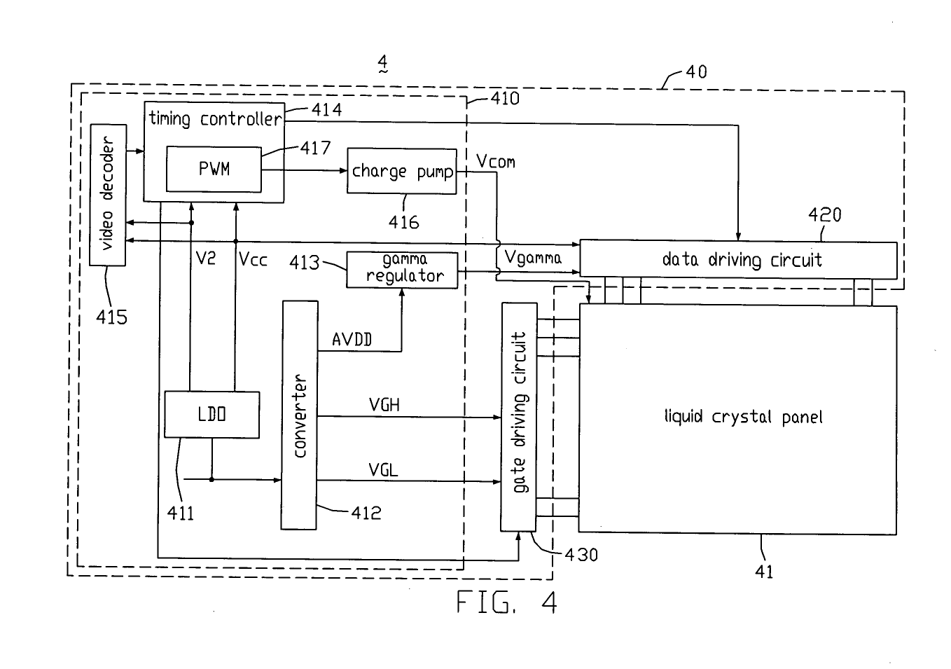

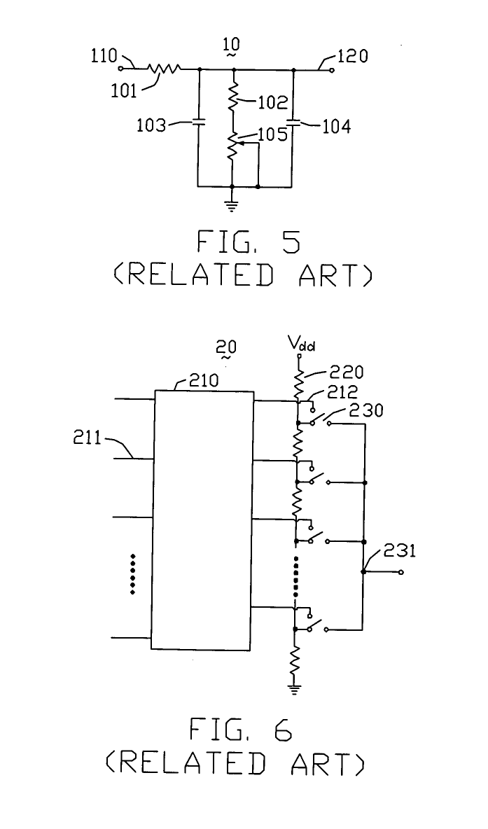

Referring to FIG. 4, this is an abbreviated block diagram including circuitry of an LCD 4 according to a second embodiment of the present invention. The LCD 4 includes a driving circuit 40 and a liquid crystal panel 41. The driving circuit 40 is used to drive the liquid crystal panel 41.

The driving circuit 40 includes a processing circuit 410, a data driving circuit 420, and a gate driving circuit 430. The processing circuit 410 includes an LDO 411, a converter 412, a timing controller 414, a video decoder 415, and a charge pump 416. The timing controller 414 includes a PWM 417. The LDO 411 and the converter 412 receive a direct current (DC) voltage from a power source (not shown). The LDO 411 provides a driving voltage “Vcc” to the video decoder 415, the data driving circuit 420 and the timing controller 414. The LDO 411 also provides a driving voltage “V2” to the PWM 417.

The converter 412 provides a high level gate voltage “VGH” and a low level gate voltage “VGL” to the gate driving circuit 430. The converter 412 also provides a main driving voltage “AVDD” to the gamma regulator 313. The gamma regulator 313 divides the main driving voltage “AVDD” so as to provide a gray scale voltage “Vgamma” to the data driving circuit 420.

The video decoder 415 receives analog video signals, and converts the analog signals into digital signals. The digital signals are provided to the timing controller 414.

The timing controller 414 provides a plurality of gate signals to the gate driving circuit 430, and provides a plurality of data signals to the data driving circuit 420. The PWM 417 provides a periodic pulse signal to the charge pump 416. The charge pump 416 and the PWM 317 together constitute a common voltage modulator (not labeled). The processing circuit 410 functions similarly to the processing circuit 310.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the invention to the full extent indicated by the broad general meaning of the terms in which the appended claims are expressed.

What is claimed is:

1. A driving circuit for a liquid crystal display, the driving circuit comprising:
a pulse generator configured for providing a pulse signal; and
a charge pump configured for providing a common voltage according to the pulse signal;
wherein the common voltage is adjusted by adjusting a duty ratio of the pulse signal, and the precision of adjustment of the common voltage is determined according to a resolution of the pulse signal.

2. The driving circuit in claim 1, wherein the charge pump comprises a voltage input terminal, a first resistor, a second resistor, a first capacitor, a second capacitor, a third capacitor, a first diode, a second diode and a voltage output terminal, the voltage input terminal being connected to ground via the resistor, a positive pole and a negative pole of the first diode, a positive pole and a negative pole of the second diode, the second resistor, and the third capacitor, the voltage input terminal being further connected to the positive pole of the second diode via the first capacitor, the voltage output terminal being connected to ground via the third capacitor, the second capacitor being connected between the positive pole of the first diode and ground, the voltage input terminal being further connected to the pulse generator, the voltage output terminal being configured for outputting the common voltage.

3. The driving circuit in claim 2, wherein a value of the common voltage is an integrated voltage of the pulse signal when flowing to the second capacitor via the first resistor.

4. The driving circuit in claim 3, wherein the pulse generator is a pulse width modulator.

5. The driving circuit in claim 1, wherein the resolution of the pulse signal is a binary quotient of a predetermined range of variation of the common voltage.

6. A liquid crystal display comprising:
a liquid crystal panel configured for being driven to display images;
a driving circuit configured for driving and controlling the liquid crystal panel,
the driving circuit comprising:
a pulse generator configured for providing a pulse signal; and
a charge pump configured for providing a common voltage to the liquid crystal panel according to the pulse signal;
wherein the value of the common voltage is adjusted by adjusting a duty ratio of the pulse signal, and the precision of adjustment of the common voltage is determined according to a resolution of the pulse signal

7. The liquid crystal display in claim 6, wherein the charge pump comprises a voltage input terminal, a first resistor, a second resistor, a first capacitor, a second capacitor, a third capacitor, a first diode, a second diode and a voltage output terminal, the pulse generator being connected to the voltage output terminal, the voltage input terminal being connected to ground via the resistor, a positive pole and a negative pole of the first diode, a positive pole and a negative pole of the second diode, the second resistor, and the third capacitor, the voltage input terminal being further connected to the positive pole of the second diode via the first capacitor, the voltage output terminal being connected to ground via the third capacitor, the second capacitor being connected between the positive pole of the first diode and ground, the voltage input terminal being further connected to the pulse generator, the voltage output terminal being connected to the pulse generator.

8. The liquid crystal display in claim 7, wherein the value of the common voltage is an integrated voltage by the pulse signal when flowing to the second capacitor via the first resistor.

9. The liquid crystal display in claim 6, wherein the driving circuit further comprises a data diving circuit for providing a plurality of gray scale voltages to the liquid crystal panel and a gate driving circuit for providing a plurality of scanning signals to the liquid crystal panel.

10. The liquid crystal display in claim 9, wherein the pulse generator further provides a plurality gate control signals to the gate driving circuit and a plurality of data control signals to the data driving circuit.

11. The liquid crystal display in claim 6, wherein the pulse generator is a scaler.

12. The liquid crystal display in claim 11, wherein the scaler comprises a pulse width modulator, the pulse width modulator being capable of generating and a pulse signal and modulating a duty ratio of the pulse signal.

13. The liquid crystal display in claim 12, wherein the driving circuit further comprises a low dropout regulator, a converter and a gamma regulator, the low dropout regulator providing driving voltages to the data driving circuit and the scaler, the pulse width modulator and the data driving circuit, the gamma regulator providing gate voltages to the gate driving circuit and main driving voltage to the gamma regulator, the gamma regulator providing a gamma voltage to the liquid crystal panel.

14. The liquid crystal display in claim 6, wherein pulse generator is a timing controller.

15. The liquid crystal display in claim 14, wherein the timing controller comprises a pulse width modulator, the pulse width modulator being capable of generating and a pulse signal and modulating a duty ratio of the pulse signal.

16. The liquid crystal display in claim 15, wherein the driving circuit further comprises a video decoder, a low dropout regulator, a converter and a gamma regulator, the video decoder converting an analog signal to a digital signal and providing the digital signal to the timing controller, the low dropout regulator providing driving voltages to the data driving circuit and the scaler, the pulse width modulator and the data driving circuit, the gamma regulator providing gate voltages to the gate driving circuit and main driving voltage to the gamma regulator, the gamma regulator providing a gamma voltage to the liquid crystal panel.
